(19) United States
(12) Patent Application Publication
(10) Pub. No.: US 2013/0066710 A1
(43) Pub. Date: Mar. 14, 2013

(54) INCLUDING CONTENT ITEMS IN ADVERTISEMENTS

(71) Applicant: Nadav A. Zimak, San Francisco, CA (US)

(72) Inventor: Nadav A. Zimak, San Francisco, CA (US)

(73) Assignee: DIGG, INC., San Francisco, CA (US)

(21) Appl. No.: 12/716,221

(22) Filed: Mar. 2, 2010

(51) Int. Cl. G06Q 30/00; G06F 17/30; G06Q 10/00

(52) U.S. Cl. 705/14.43; 705/14.44; 705/14.52; 707/723; 707/E17.014

(57) ABSTRACT

Generating an advertisement unit is disclosed. A selection of one or more content items is received. Each of the content items has an associated quality score. A representation of at least one of the content items is included in a generated advertisement. The advertisement also includes, for each included content item, an associated link configured to, when activated by a viewer of the advertisement, direct the viewer to an instance of the respective included content item.

### BACKGROUND OF THE INVENTION

Advertisements are commonly placed alongside non-advertisement information (such as news articles and images) such that a viewer of the non-advertisement information will also be exposed to the advertisement. Unfortunately, viewers may ignore or not otherwise notice those advertisements. In the context of web pages, one reason that viewers ignore (whether consciously or subconsciously) advertisements is that publishers routinely locate the advertisements in standard locations such as to the right of the information, or in a header or footer, and over time viewers condition themselves to pay less attention to anything appearing those locations. Viewers may be further prone to ignoring advertisements that comprise subject matter that is of little or no interest of them.

There therefore exists an ongoing need to improve advertisements.

### BRIEF DESCRIPTION OF THE DRAWINGS

Various embodiments of the invention are disclosed in the following detailed description and the accompanying drawings.

FIG. 1 illustrates an embodiment of an environment in which advertisements are displayed.

FIG. 2 illustrates an embodiment of an interface to a preference system.

FIG. 3 illustrates an embodiment of a content permalink.

FIG. 4 illustrates an embodiment of an interface to a preference system.

FIG. 5 illustrates an embodiment of an interface to a preference system

FIG. 6 illustrates an embodiment of an interface to a preference system.

FIG. 7 is a flow chart illustrating an embodiment of a process for recording a preference for a content item.

FIG. 8A is an example of a content item.

FIG. 8B illustrates an embodiment of an interface to a preference system.

FIG. 9 illustrates an embodiment of an interface to a preference system.

FIG. 10 illustrates an embodiment of an interface to a preference system.

FIG. 11 illustrates an embodiment of an interface to a preference system.

FIG. 12 illustrates an embodiment of an interface to an advertising server.

FIG. 13 illustrates an embodiment of an interface to an advertising server.

FIG. 14 illustrates an embodiment of an advertisement.

FIG. 15 illustrates a portion of a search engine provider's website as rendered in a browser.

FIG. 16 illustrates a portion of a blog as rendered in a browser.

FIG. 17 illustrates a portion of a news website as rendered in a browser.

FIG. 18 is a flow chart illustrating an embodiment of a process for generating an advertisement unit.

FIG. 19 is a flow chart illustrating an embodiment of a process for serving an advertisement unit.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

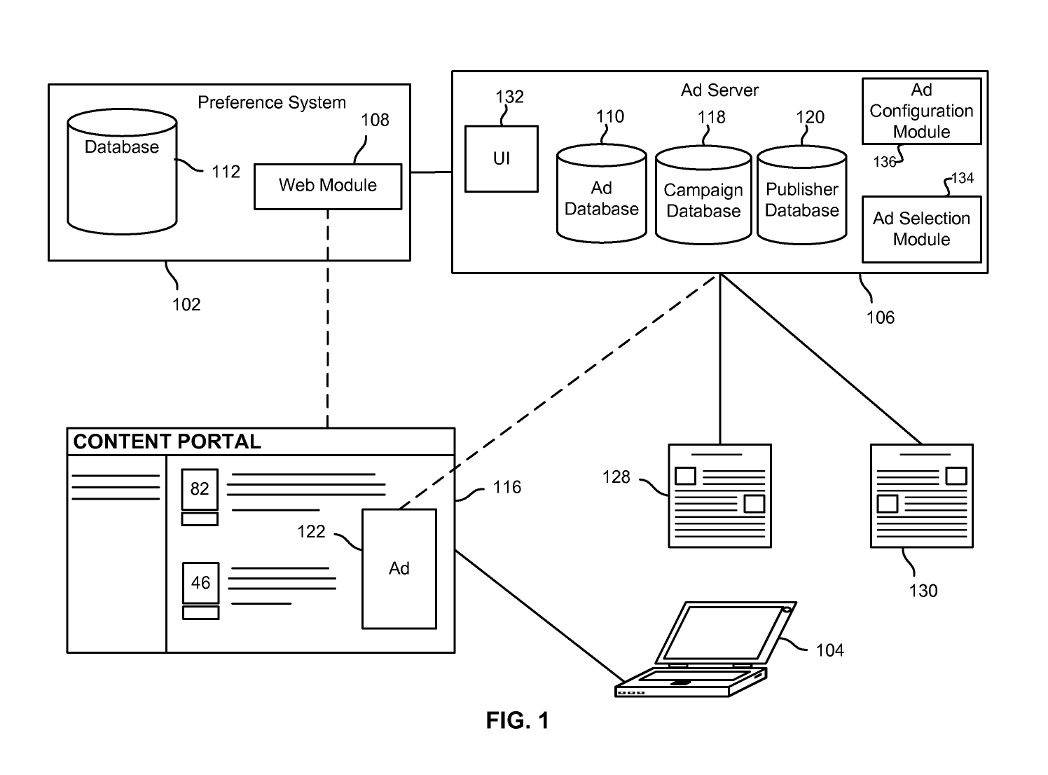

FIG. 1 illustrates an embodiment of an environment in which advertisements are displayed. In the example shown, users (e.g., a user of client 104) indicate preferences for content via preference system 102. Examples of content include news articles, blog posts, reviews, various other web pages, podcasts, photographs, and videos published by various publishers. Examples of clients include personal computers, laptops, cellular phones/personal digital assistants, and other types of information appliances such as set-top boxes, game consoles, broadband routers, file servers, video servers, and digital video recorders, as applicable.

As will be described in more detail below, preference system 102 is configured to provide a link to content (e.g., a hyperlink to site 128) and summary information pertaining to that content, and also to allow users to indicate their preferences for the content by making a variety of interactions. For example, users can provide quantitative feedback such as a “thumbs up” (also referred to herein as a “digg”) to indicate their preference for content and can also “bury” content to indicate problems with the content. Users can also discuss the content with one another. These actions are referred to herein collectively as “preference events.” In various embodiments, publishers register their content with system 102. Users can also register content with system 102 by providing a uniform resource locator (URL) of the content. In such scenario, the user's registration (also referred to herein as a “submission”) of the content is another example of a preference event.

When content is submitted to system 102, an entry for the content is created in database 112. Information such as the submission time and the user who submitted the content are stored and counts associated with the content are initialized. Additionally, information associated with the submitting user is modified as appropriate. For example, a count of the number of content items submitted by the user is incremented, and the content is made available in areas such as the user's profile and the profile areas of the user's friends (described in more detail below), if applicable.

Preference system 102 includes a web module 108 that provides typical web server functionality such as serving website 116 and capturing user input. In the example shown, web module 108 is an Apache HTTP server that supports running PHP scripts. In various embodiments, the functionality of website 116 is exposed to users via one or more APIs, as applicable. Web module 108 is interfaced with a database 112, such as through a MySQL database backend. Whenever a preference event occurs (e.g., whenever a user submits, diggs, buries, or comments on content), the event is recorded in database 112 along with associated information such as the identity of the user and a time/date stamp. In some embodiments, the infrastructure provided by portions of preference system 102 is located on and/or replicated across a plurality of servers rather than the entirety of preference system 102 being collocated on a single platform. Such may be the case, for example, if the contents of database 112 are vast and/or there are many simultaneous visitors to site 116.

Also shown in FIG. 1 is advertisement server 106, which is configured to provide advertisements (e.g., 122) for display on sites such as sites 116, 128, and 130. Ad server 106 can also provide advertisements to applications other than web browsers, such as via one or more APIs. As will be described in more detail below, advertisers (or their representatives) provide ad configuration module 136 (via interface 132) with specifications for advertisements that are in turn stored in ad database 110. Advertisers can also create and maintain campaigns, which are stored in campaign database 118. Publishers registered with ad server 106 are able to specify various conditions under which syndicated advertisements should be shown on their sites. That information is stored in publisher database 120 and is also exposed via user interface 132. When requests for advertisements are received by ad server 106, ad selection module 134 selects an appropriate advertisement to be displayed.

Whenever server 106 performs a task (such as generating an advertisement), either a single component or a subset of components or all components of server 106 may cooperate to perform the task. Similarly, in some embodiments portions of server 106 are provided by one or more third parties.

In some embodiments the functionality of ad server 106 is incorporated into system 102. Ad server 106 can also be physically separate from system 102, but operated by the operator of system 102. In various embodiments, ad server 106 is controlled by a party that is separate from the operator of preference system 102. In that scenario, ad server 106 is configured to obtain any necessary information from system 102 (e.g., pertaining to preference events) via an API or via scraping techniques, as applicable. As will be described in more detail below, ad server 106 can also be configured to construct advertisements using data sources other than system 102, such as a search engine or standalone restaurant review site.

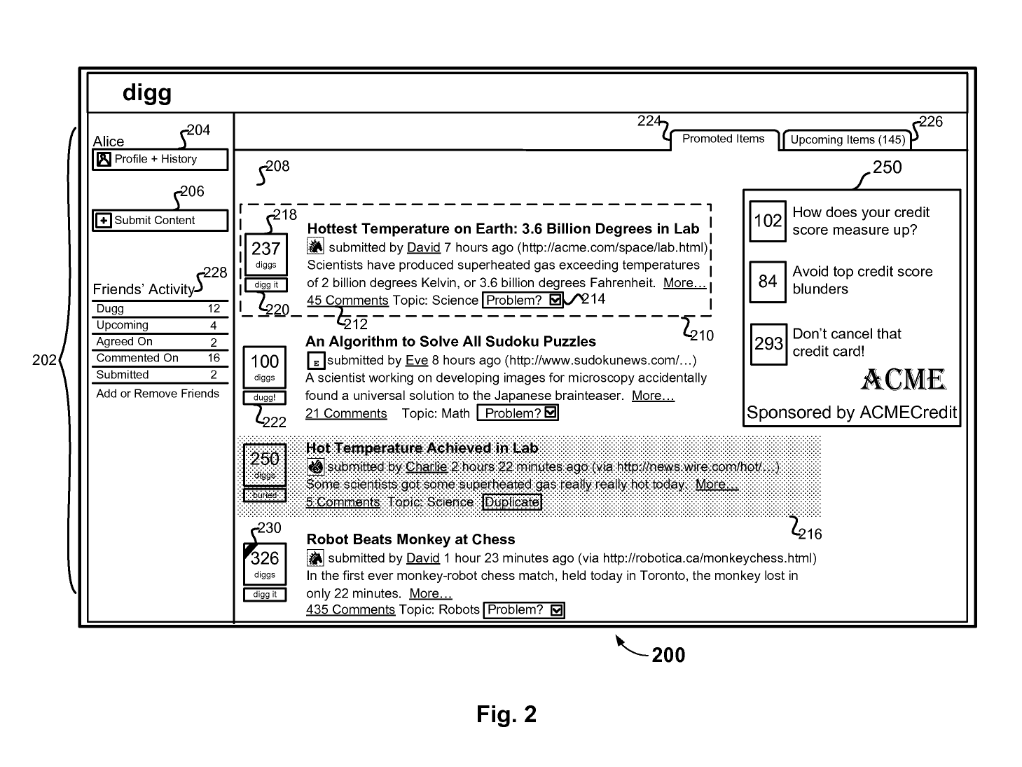

FIG. 2 illustrates an embodiment of an interface to a preference system. The example shown is an implementation of a portion of website 116, as rendered in a browser. A user, known as “Alice” is logged into site 116. Interface 200 includes a sidebar 202 that provides access to various system services. For example, by selecting region 204 of sidebar 202, Alice is presented with an interface that permits her to view her profile and manage account settings such as her current email address and password; view previous preference events she's taken (her “history”); and access friend-related features described in more detail below. By selecting region 206, Alice will be presented with an interface through which she can submit content for inclusion on system 102.

Region 208 displays representations of multiple content entries such as entry 210. In the example shown, each entry includes a title and other associated information, such as who submitted the content and when, the external URL of the content, the category to which the content belongs, and a summary of the content. Links are provided to the content directly (such as by clicking on the title), as well as to an area of site 116 associated with each specific content item, referred to herein as the content's “permalink.” For example, by clicking on the comments link (212) of the story, Alice will be presented with the comments portion of the permalink described in more detail below.

Content entry 210 also includes a problem reporting region 214. Users may report problems for a variety of reasons. For example, the first content entry and the third content entry are both news articles describing the same news—scientists superheating a gas. Accordingly, Alice selects the problem, “duplicate” content, which has the effect in this embodiment of graying out the content, represented here by stippling (216).

Each content entry has one or more scores associated with it. In the example shown, the “digg” score (218) for each item is displayed, as is an interactive region beneath the score (box 220) that allows a user to “digg” the item. The first item has been dugg 237 times, but has not been dugg by Alice. As described in more detail below, if Alice were to select region 218, a variety of actions would be immediately taken, including increasing the digg score of the story and updating the region's text from “digg it” to “dugg!” as shown in region 222.

Alice is currently viewing a “promoted items” (224) view of region 208. This means that all of the content items presented to Alice on the current view of the interface have exceeded a promotion threshold. One example of a promotion threshold is the raw number of diggs. Other requirements/factors may be used for thresholding in addition to or instead of a digg score, such as requiring that a certain amount of time elapse between content submission and promotion, the speed with which content is being dugg by others, the identity of those digging the content, and other information associated with users that have dugg the content. Because some threshold of users must agree that a content item has merit before being promoted, content items shown in promoted view 224 are unlikely to contain spam or otherwise be inherently inappropriate for Alice's viewing. In some embodiments, different thresholds are used for different content. For example, the promotion of a math related news article may only require 100 diggs whereas an article about the president may require 500 diggs.

If Alice selects the upcoming content tab (226), only content which has not yet met the appropriate threshold will be displayed. For example, newly submitted content which has not yet been “dugg” by a sufficient number of people will be presented by selecting tab 226. In some embodiments, if content languishes in the upcoming pool for more than a certain period of time without receiving a sufficient digg score to be promoted (e.g., for a week), the content is removed from the pool and can only be found via its permalink or through a search. In some embodiments, such content is deleted from database 112, because it is indicative of problematic content such as spam, extremely biased or unfounded news articles, etc. Similarly, if enough users bury content, the content may be removed from the pool and/or database 112. In other embodiments, other views of content may be presented as applicable, such as a view that unifies both the promoted and the upcoming groups.

Portion 228 of interface 200 displays the recent activities (preference events) of Alice's friends. For example, in the last 48 hours, Alice's friends have submitted two content items, dugg twelve content items, and commented on sixteen content items, as reflected in dashboard 228. Of the twelve items her friends have dugg, four of the items have not yet been promoted. In some embodiments, assorted visual cues of her friends' activity are presented throughout website 116. In the example shown, items dugg by Alice's friends are notated by a banner (230) placed across the digg score. In other cases, other cues may be used.

Also shown in FIG. 2 is an advertisement 250, sponsored by a credit bureau, “ACME Credit.” The advertisement includes a representation of three content items, each of which pertains to credit scores. The content items shown in advertisement 250 correspond to items accessible to Alice via website 116, but are represented in the advertisement by only their respective titles and digg scores. Techniques for creating and serving ads such as ad 250 will be described in more detail below.

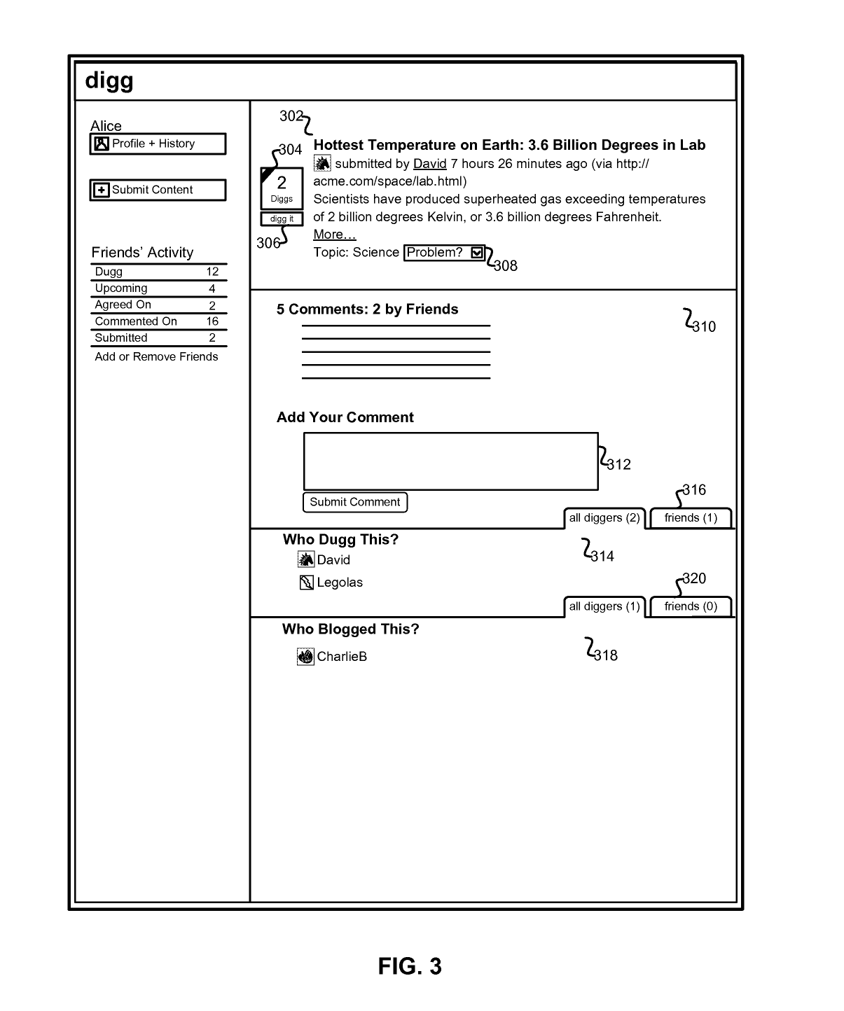

FIG. 3 illustrates an embodiment of a content permalink. The example shown is an implementation of a portion of website 116 as rendered in a browser. Each content item submitted to system 102 has a corresponding permalink page that includes content assembled dynamically from the information stored in database 112.

In the example shown, content 302 (a news article) was recently submitted to server 102 (26 minutes ago) by a user, David, who also dugg the story. Alice has David listed under her profile as her friend. As a result, the digg count includes a visual indication 304 that article 302 was dugg by a friend. In some cases, Alice and David know each other and have each other, mutually, on their list of friends. In other cases, the relation may be one sided. For example, David may be a columnist or famous personality whose opinion Alice values.

The digg score of article 302 is currently two (304) and the article has not met the threshold(s) required for the story to be promoted out of the “upcoming” area.

In the interface shown in FIG. 3, Alice can click digg box 306 to indicate her preference for the article. In some embodiments, additional actions are taken when Alice diggs a story. For example, if she has configured her blog settings, Alice can specify that stories that she diggs be posted to her blog as she diggs them. Similarly, Alice can configure her personal website (e.g., with a JavaScript) to automatically syndicate recent activities taken in response to stories.

She can report a problem with the article (bury it) by selecting an option from problem dropdown 308. Reporting options include “duplicate” article (to report that article 302 is a duplicate of another article), “bad link” (to report that the link to the full text of the article is defective), “spam” (to indicate that the article is fraudulent or spam), “inaccurate” (to indicate that there are factual problems with the article), and “old news” and “this is lame” to indicate that the article is not newsworthy. In some embodiments, bury events are anonymous site wide and are not replicated, for example, in a user's publicly accessibly digging history. One reason for this is to minimize the chances of a “flame war” occurring, for example, when a well known user negatively rates content or a comment.

In various embodiments, different problem reporting options are made available based on the type of content. For example, for video content, a bury option of “poor quality” can be included to allow users to report blocky, choppy, or otherwise defective video. For products, a bury option of “mine broke” would allow a user to indicate that the product was flimsy.

Region 310 displays comments that users have made about article 302. Thus far, a total of five comments have been left about article 302, two of which were left by Alice's friends. Alice can submit comments by entering information into region 312 of FIG. 3.

In region 314, Alice is currently viewing a list of all the users who dugg article 302. Suppose David is Alice's friend, but Legolas is not. If Alice selects friends tab 316, the view in region 314 will change to show only David's name and avatar icon.

In region 318, Alice is currently viewing a list of the users who have blogged article 302. Charlie is the only person who has blogged the article so far and he is not Alice's friend. Therefore, if Alice were to select friends tab 320, no names would be shown.

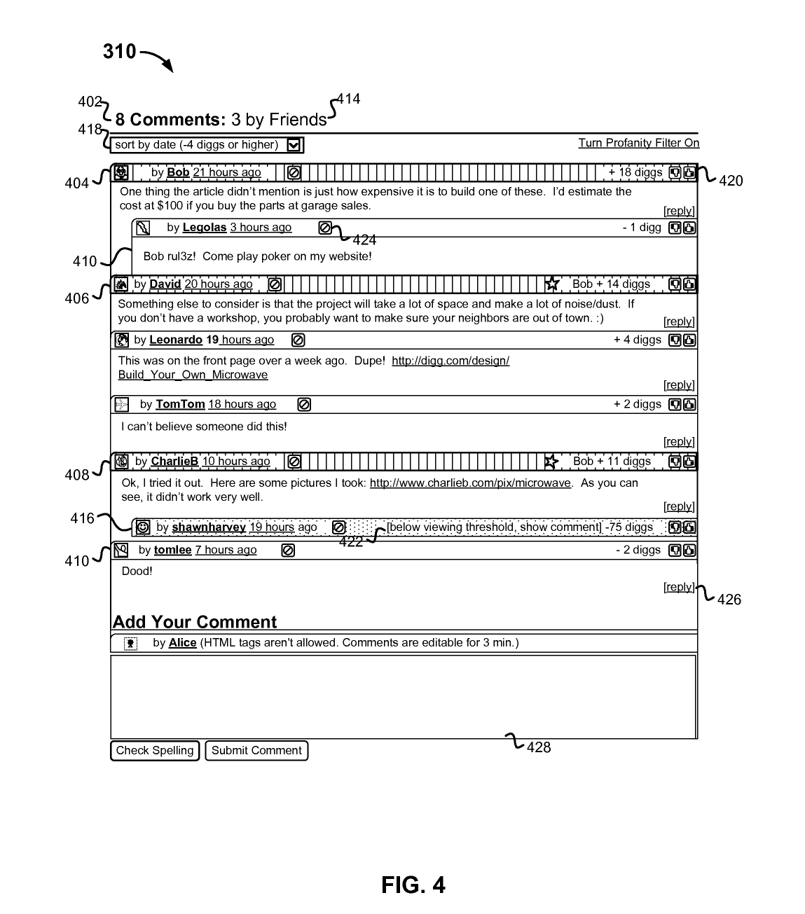

FIG. 4 illustrates an embodiment of an interface to a preference system. The example shown is an implementation of portion 310 of website 116, as rendered in a browser. In the example shown, Alice is viewing comments associated with an article. The article currently has eight comments (402), sorted by date. A threshold of −4 diggs or higher has also been applied (418). Thus, comment 416, which has been buried 75 times, is hidden. In the example shown, only the header of a buried comment is displayed, along with a link to reveal the hidden comment (422). Additionally, the header of comment 416 is greyed out to help a user visually distinguish between buried and nonburied comments.

Comment 404 was written by Bob, one of Alice's friends, as was comment 406 (written by David). In this example, comments written by friends are distinguished from other comments, such as through having a differently colored header. Comments dugg by friends are also distinguished. In the example shown, Bob has written an informative comment, which 18 people have dugg. If desired, Alice can digg or bury Bob's comment by selecting the appropriate icon at 420. In the example shown, the digg icon is a green thumb pointing up. The bury icon is a red thumb pointing down. If Alice selects one of the icons, Bob's comment score is immediately updated and the thumbs are greyed out to indicate to Alice that she's already registered her preference for Bob's comment.

Suppose Alice finds comment 410 to be off topic or otherwise unhelpful. If she chooses to bury the comment, in the example shown, the comment score for comment 410 will decrement by one point. In some embodiments, if enough people bury a comment, the comment is removed from the site and/or reported to an administrator. If desired, Alice can submit one or more comments of her own. For example, she may reply to an existing comment by selecting the reply button associated with the comment (426), or create a new comment by submitting text through region 428. When Alice submits or diggs a comment, that preference event is recorded in database 112, her profile and the profiles of her friends are immediately updated.

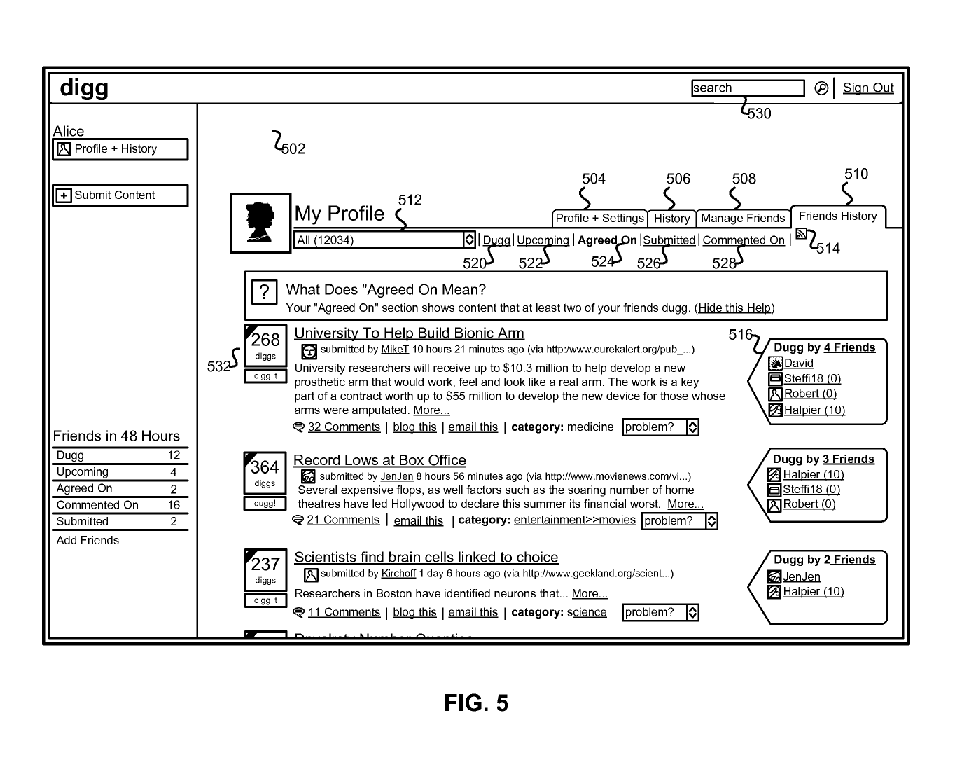

FIG. 5 illustrates an embodiment of an interface to a preference system. The example shown is an implementation of a portion of website 116 reached by selecting region 204, as rendered in a browser. In this example, Alice is viewing her profile (hereinafter “interface 502”), which has been subdivided into several tabbed views (504-510). A profile provides access to a variety of information, some of which may be publicly viewable, and some of which may be kept private. Visitors to Alice's profile will be presented with a subset of the information available to Alice. For example, while Alice sees tab 504 being labeled “Profile+Settings,” a visitor to Alice's profile would see tab 504 as leading to Alice's “Profile” only. Similarly, tab 508, which by selecting allows Alice to add and remove friends, is only available to Alice and is hidden from visitors to her profile. Alice can also add friends by visiting other users' profiles and selecting an “add this user as my friend” option located in the profile.

Alice has currently elected to view her friends' history by selecting portion 510 of interface 502. The information presented can be further customized by selecting from subsets of information. For example, if Alice selects portion 520 of interface 502, she will be presented with a listing of all of the stories that have been dugg by at least one of her friends. If she selects portion 522, she will be presented with a list of stories that have been dugg by at least one of her friends but have not yet been promoted. If she selects portion 526, Alice will be presented with a list of stories submitted by her friends, and by selecting portion 528, Alice will be presented with a list of stories that have been commented on by her friends. Other information (not shown) may also be presented in other embodiments, such as a list of comments that Alice and/or her friends have dugg.

In the example shown, Alice has elected to view stories “agreed on” by her friends (524). Each of the stories listed in this view have been dugg by at least three of Alice's friends. In various embodiments, Alice can configure the threshold and specify such information as the number of friends (or total number of diggs) required for a story to be agreed upon and/or define particular individuals whose digg is necessary for a story to be considered agreed upon, keywords that must be present in the story, etc. By making use of the “agreed on” view, Alice can readily discern the most important stories, even if she has thousands of friends. (I.e., if she sets the threshold to “agreed on by at least 10 friends,” and has 1000 friends, the number of stories she is presented with is likely to be manageable and especially relevant or interesting.) Region 516 of interface 502 indicates that four of Alice's friends have dugg story 532. Alice can also see which of her friends have dugg story 532 by hovering her input device over the digg score box of story 532.

By selecting portion 506 of interface 502, both Alice, and visitors to Alice's profile will be presented with Alice's history in a format similar to that currently shown, but limited to activities taken by Alice. Additionally, Alice may “undigg” stories and comments that she previously dugg by visiting her history.

Suppose Bob has listed Alice as his friend. Whenever Alice submits a new story, that new story immediately appears on Bob's “Friends-Submitted” list. Similarly, whenever David comments on an article, that fact is immediately reflected under Alice's tab 528 as shown in FIG. 5. As described herein, pages served by web module 108 include Asynchronous JavaScript and XML (Ajax) components. Other techniques may also be used to dynamically update site 116 as rendered in a browser (or other application) as appropriate.

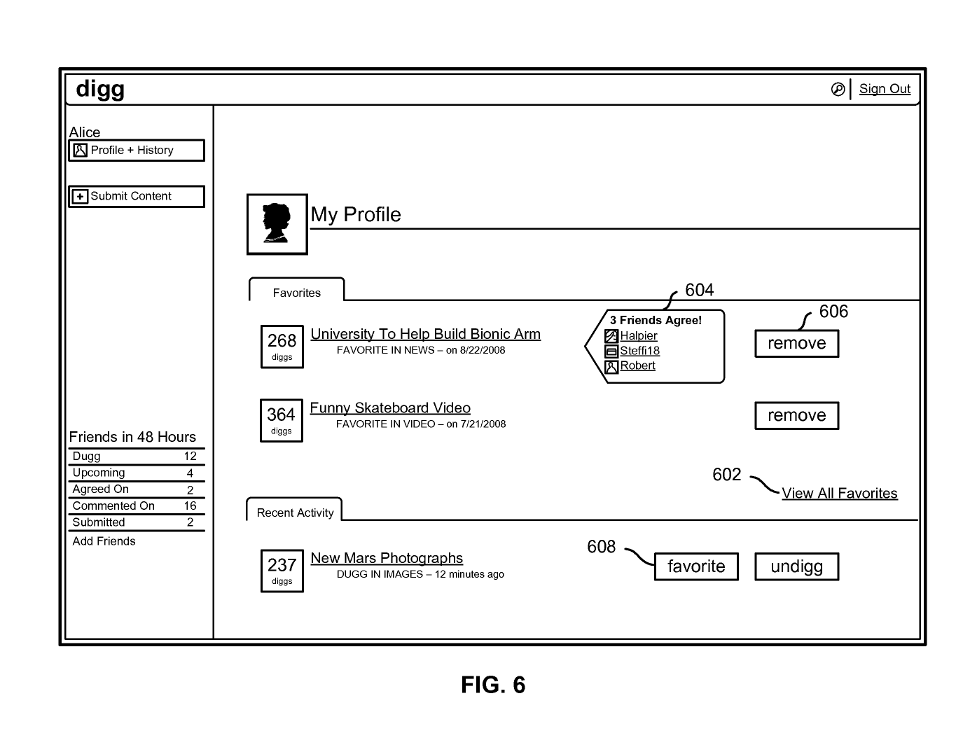

FIG. 6 illustrates an embodiment of an interface to a preference system. In the example shown, Alice is viewing a list of items that she has designated as being her favorite, e.g. by selecting region 608. In some embodiments Alice can have a single favorite item at any given time listed in her profile, also referred to herein as “My #1,” indicating that the item is Alice's #1 favorite item. In other embodiments, Alice can have a single favorite item per category (e.g., favorite sports story, favorite politics story etc.) or per type of item (e.g., favorite restaurant, favorite video, favorite news item, favorite podcast, etc.). In any of the above cases, if she subsequently marks as “favorite” another item, that newly selected item will replace the corresponding existing favorite item in Alice's profile. Items previously designated as “#1” are noted in an archive of “#1” items that can be accessed, e.g., by following a link 602.

In some embodiments, Alice can designate multiple favorites, in all categories/types of content, and a rolling list of the most recent designations is displayed in her profile, with older favorites accessible via link 602.

In various embodiments the history of Alice's favorites is color coded. For example, more recent favorites are green and older ones are red. Other visual indicators may also be used. For example, the more users that have the same content designated as favorite, the brighter the designation appears. If many users all have the same content designated as favorite right now, that content is “hot” and appears with flames around it in the “Favorite” section of Alice's profile. If only a few people have that content marked as a favorite, the content may be icy cold as indicated by a blue color scheme.

Alice can remove her “favorite” designation of content by selecting region 606. For example, suppose Alice designated a particular MP3 player (one that she owns) as a favorite. The MP3 player was actually of poor quality and subsequently broke. Alice does not want other users to think that she still approves of it, so she removes the favorite designation. If instead of breaking, Alice merely received a newer, better player, she may wish to retain the favorite designation for the old player, and also mark as favorite her new player, so that other users know that she likes both players. In some embodiments, if Alice undiggs a particular content, any favorite designations that she may have made with respect to that content are automatically removed.

Alice can also view the favorite content of her friends (and other users) by visiting their respective profiles and selecting a “favorites” tab. Alice can also perform a user search to find other users with similar favorites to discover new friends, and/or to discover new content. For example, Alice could designate a particular restaurant as her favorite and then perform a search to determine “where people who also like my #1 restaurant buy books?” Alice could designate a movie as being her favorite and then determine “what news stories are people who also share my favorite movie reading now?”

Alice can also see which content she and her friends have commonly designated as favorite, e.g. through information displayed in region 604. In some embodiments Alice can also see the aggregate favorites of her friends by selecting a “see my Friends' #1s” link within her own profile, which in turn shows one favorite per friend, such as the item most recently designated as favorite by that friend. The aggregate view is customizable, and also allows, e.g., Alice to sort the favorites by the number of friends who at one point in time (or currently) also have designated the content as a favorite.

Statistics on the favorite content of users site-wide is tracked and can be displayed according to different periods of time, different groups of users, different categories/types of content/etc. For example, Alice can view “the content most often designated as favorite of all time,” search for “the most frequently #1 restaurant [bar, dry cleaner] in Chicago [or a zip code, or an area code],” see “the product with the most favorite designations right now,” search for “the MP3 player with the most #1 designations between December 1 and January 31 of last year,” find “the #1 fiction book as designated on the lists of female users between the ages of 13 and 25,” and so on. A “top ten” list of favorite content can also be displayed, e.g. showing the relative positions of content based on the number of favorite designations, such as “this story is currently #3 in the ranking, up from #6 last week.”

Time-based information can also be used to indicate the “staying power” of the favorite designations for content. For example, if many people leave the same content at the top of their favorite list before replacing it with other content, this statistic can be measured, searched for, etc. Examples include a search for “the content with the longest average streak of being a user's favorite content,” “the content that, once designated as a favorite, remains a favorite the least amount of time,” and so on.

Favorite content can also be analyzed to determine particular topics or subjects of interest to a user which can subsequently be consumed by modules such as server 106. For example, suppose Alice designates as favorite a photograph of the fictional town of Springfield, a video clip of The Simpsons television show, and an article about a chain of convenience stores redecorating with a Simpsons theme. Collectively, the content marked as favorite indicates that “The Simpsons” is a concept in which Alice has a strong interest.

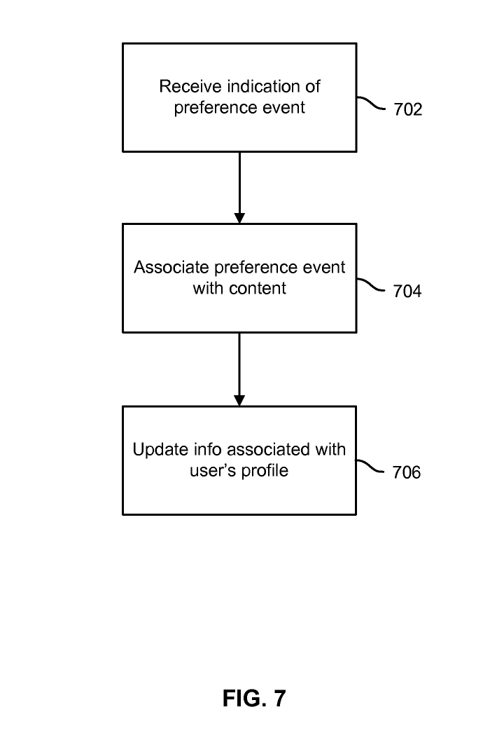

FIG. 7 is a flow chart illustrating an embodiment of a process for recording a preference for a content item. The process begins at 702 when an indication that a preference event has occurred is received. For example, when Alice selects digg box 306 shown in FIG. 3, her preference is received at 702. Other examples of preference events include submitting a content item, burying a content item, and commenting on an item. At 704, the preference event is associated with the content item and any associated scores are updated as applicable. For example, at 704, Alice and story 302 are linked in database 112 and the digg score of story 302 is increased in database 112 from two to three. At 706, information associated with the user's profile is updated. For example, views of Alice's digging history (including the friend views of users who have listed Alice as a friend) are updated to include the dugg story and an indication that Alice dugg it.

Additional Types of Content

As used herein, permalink pages for content items made available via system 102 include links or other pointers to the original form of the content (e.g., news articles and podcasts), such as may be hosted by a third party publishing site. In some embodiments, users submit the content itself (e.g. the full text of articles, and the audio file) rather than or in addition to a link to the content, and the techniques described herein are adapted accordingly.

As explained above, content contributions are not limited to news articles. Other content can also be submitted, dugg, buried, commented on, and included in advertisements and the techniques described herein can be adapted as appropriate. For example, preference events taken on various types of content can be associated with a profile and shared with friends in a manner similar to that described in conjunction with FIG. 5.

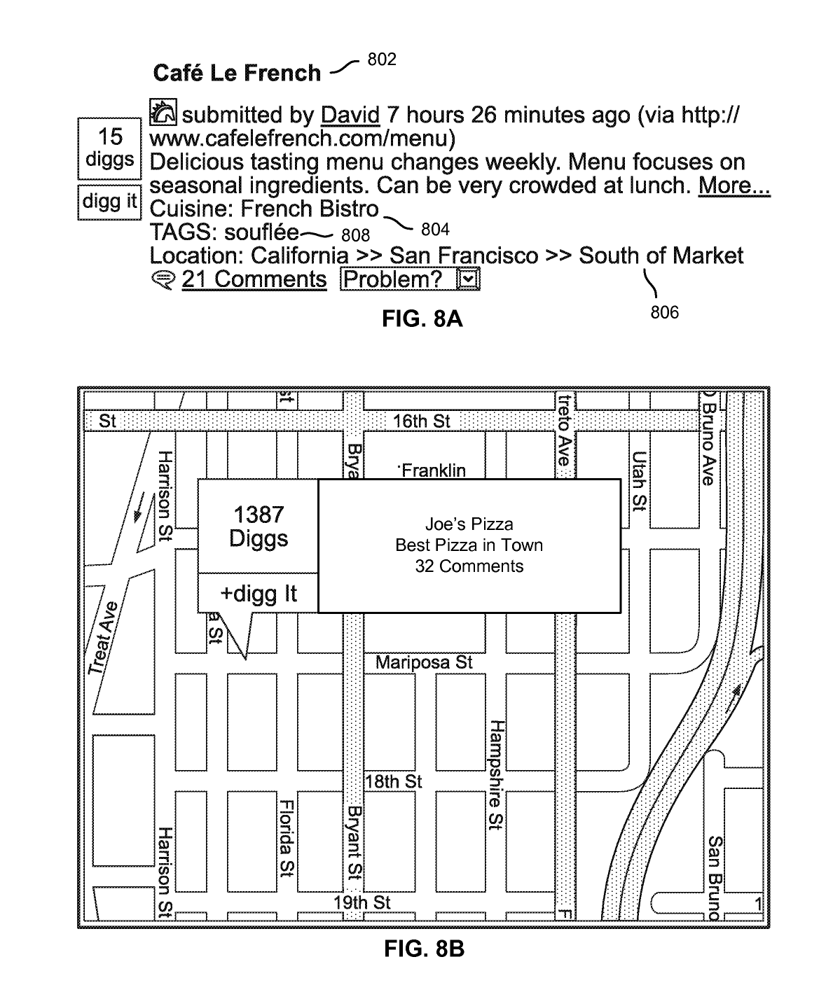

FIG. 8A is an example of a content item. The example shown represents a restaurant submission. The name of the restaurant (802) is included, as is information such as who submitted the restaurant, the URL of the restaurant, the type of cuisine it serves (804), and the general location of the restaurant (806). Users may perform such actions as searching for restaurants by cuisine type and/or location, and limiting results to ones having a threshold number of diggs. Restaurants having no or few diggs can be displayed as “upcoming restaurants,” separated from “promoted restaurants” which have digg scores exceeding a threshold. Users can also supply additional information about their preferences for the restaurant, such as by supplying one or more tags (808) that indicate attributes such as “ambiance” or signature dishes. Which fields/tags are collected at submission time (and which, if any, can be added subsequently) and shown can be configured as appropriate depending on the type of content. For example, in the case of a product, a stock photo of the product may be included.

FIG. 8B illustrates an embodiment of an interface to a preference system. In the example shown, digging functionality has been combined with mapping functionality. When a user searches a map, such as a web-based map service, for nearby restaurants, entries on the map include an indication of the number of diggs a business has had and the ability to digg or comment on the business directly from the map interface.

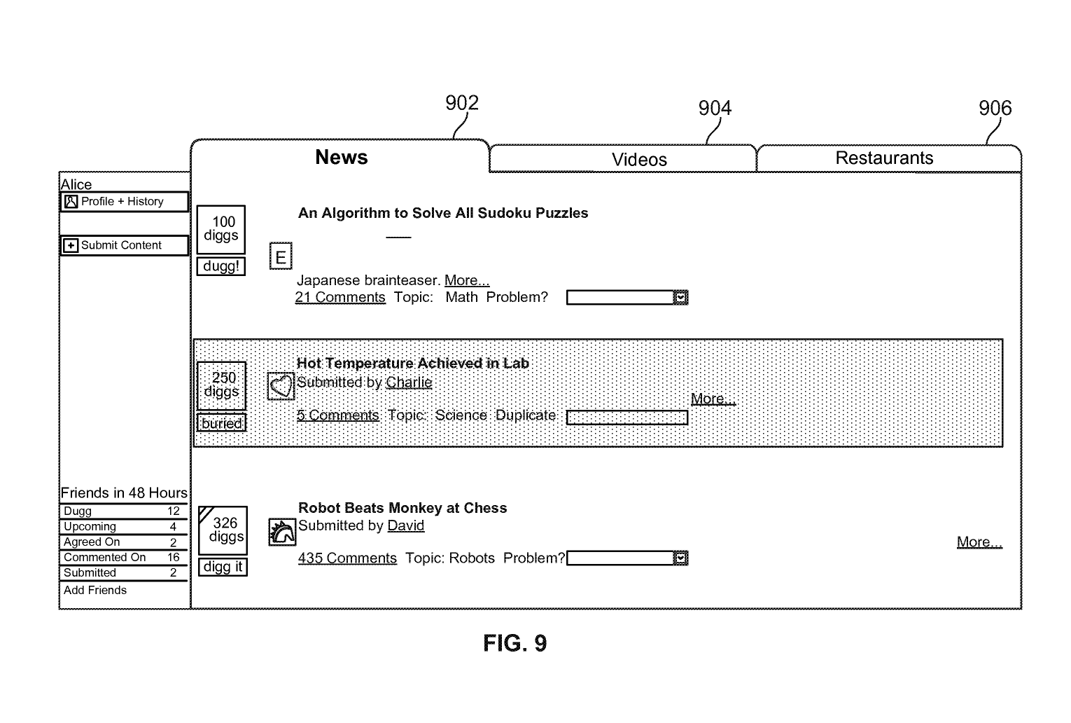

FIG. 9 illustrates an embodiment of an interface to a preference system. In the example shown, the interface unifies a user's preference for items across multiple genres of content. For example, the user can digg for news (902), videos (904), and restaurants (906) all through the same interface. Additionally, using the interface shown in FIG. 9, a visitor to Alice's profile can learn which news stories she's been digging as well as learn which restaurants she diggs or doesn't digg. Similarly, Alice can customize the views of each of the tabs (902, 904, 906) to display only restaurants her friends of agreed on, restaurants nearby (e.g., by selecting a region on a map or entering a ZIP code) that at least one friend has dugg, etc.

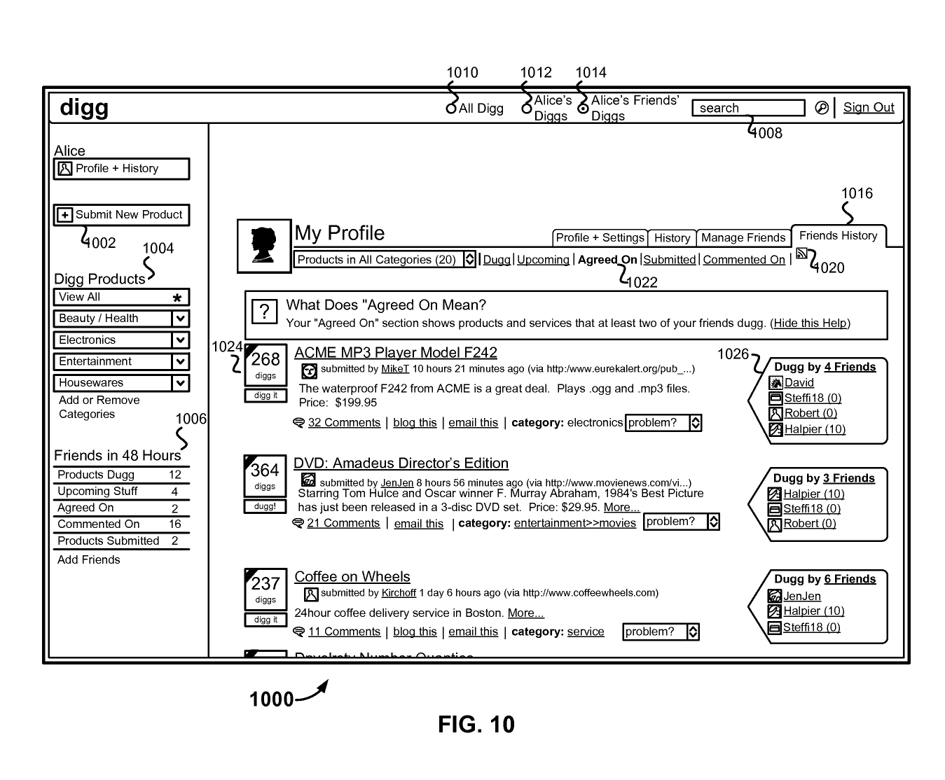

FIG. 10 illustrates an embodiment of an interface to a preference system. The example shown is an implementation of a portion of website 116 which includes the ability to submit, digg, and comment on products (including software), as rendered in a browser. In this example, Alice has selected to view products agreed on by her friends (1022).

Alice can submit a new product review by selecting portion 1002 of interface 1000. She can view products in one or more categories by selecting the appropriate portion of region 1004. Portion 1006 of interface 1000 displays the recent activities of Alice's friends in a dashboard format.

Region 1026 of interface 1000 indicates that four of Alice's friends have dugg product 1024, the ACME MP3 player. Alice can also see which of her friends have dugg product 1024 by hovering her input device over the digg score box of product 1024. In some embodiments, Alice can interact with region 1026, such as by being presented with a dialogue that offers to send an email to all of her friends listed in the region. In some embodiments, additional actions can be taken with product 1024. For example, Alice may be presented a “buy this product now” icon or link.

In some embodiments, profile visitors (including Alice) are presented with the option to search (1008) all of site 116 for product keywords (1010), search Alice's diggs for product keywords (1012), and/or search diggs made by Alice's friends for product keywords (1014). For example, a visitor to Alice's profile can search for MP3 players that she has dugg or commented on. In some embodiments, search interface 1008 includes the ability to filter results on meta information such as regions for DVDs, languages for books, etc. In some embodiments, views (and searches) can be limited by other factors, such as location (distance from Alice), availability (whether a product is in stock and how quickly it can arrive), etc.

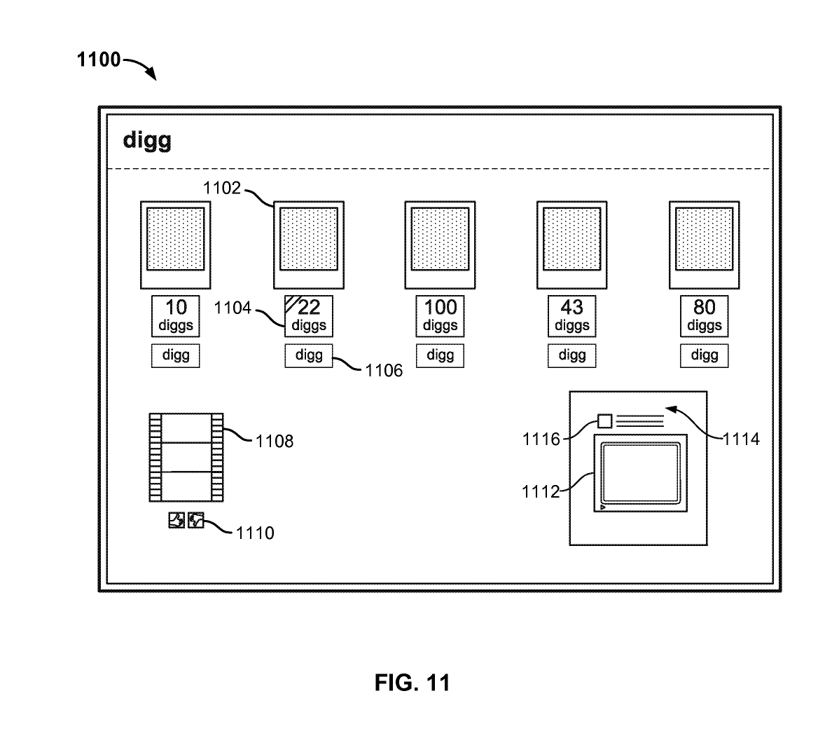

FIG. 11 illustrates an embodiment of an interface to a preference system. The example shown is an implementation of a portion of website 116 which includes the ability to submit, digg, and comment on photographs and video, as rendered in a browser. In the example shown, photograph 1102 was dugg by a friend, as indicated by banner 1104. By selecting digg box 1106, a visitor can indicate a preference for the photograph shown. In some embodiments, visitors indicate their preference for content such as video 1108 by selecting an icon such as icon 1110.

The content shown in interface 1100 can be presented in a variety of ways. For example, video content may be represented as an icon, such as the filmstrip icon shown at 1108. A screen shot of the first frame of the video may also be shown, and interactions, such as hovering a mouse over region 1108 could trigger actions such as causing the video to be played in the browser. In some cases, it may not be possible to embed the content directly into the interface shown in FIG. 11. In such a case, the video is shown in a format similar to content item 210 (1116), and a preview button 1114 is included. When preview button 1114 is selected, a video player 1112 automatically slides out in which the video can be displayed. Permalink pages such as the one shown in FIG. 3 can be adapted for photograph and video content as appropriate, and users may comment, blog, and take other actions with respect to visual and other content (such as songs) as appropriate.

Advertisements

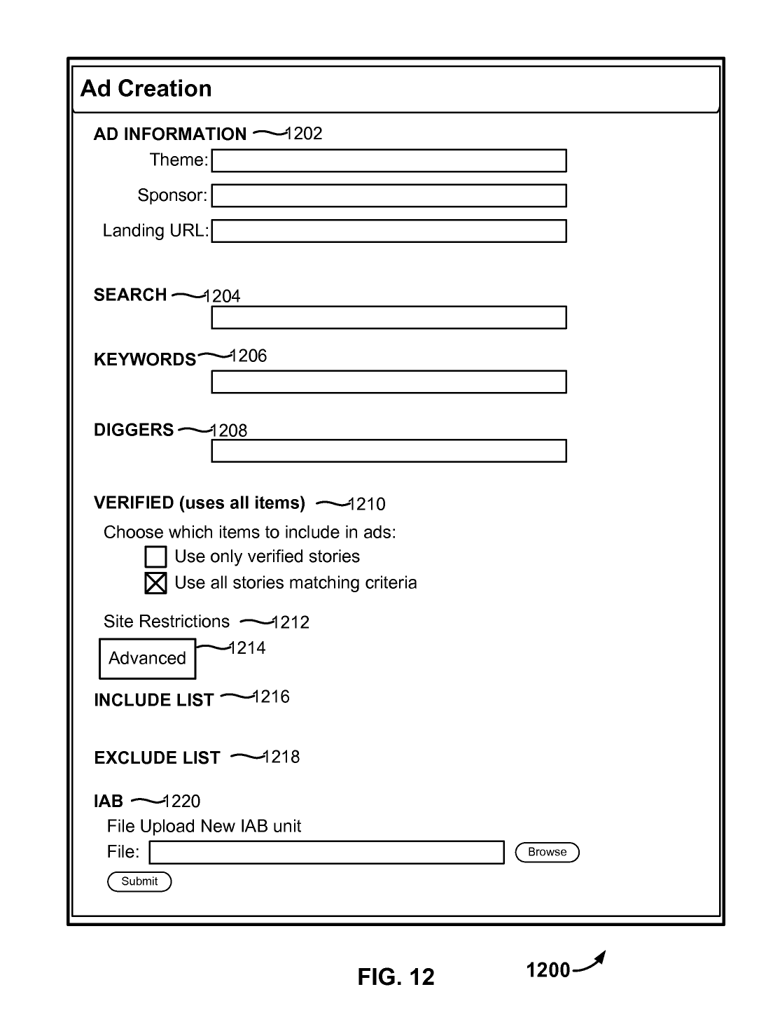

FIG. 12 illustrates an embodiment of an interface to an advertising server. The example shown is an interface to ad configuration module 136. By completing various fields shown in interface 1200, advertisers are able to specify what content should be included in their advertisements. For example, using interface 1200, an advertiser is able to specify rules by which the three content items included in advertisement 250 will ultimately be chosen from among the thousands (or more) various content items included in database 112.

Region 1202 of interface 1200 collects basic administrative information pertaining to the advertisement. Region 1204 is configured to accept as input a search string. The string is used to search database 112 for matching content items. Any matching items are included in a pool of candidate content items.

One way to simplify the selection of content items is for the advertiser to sign up for an account with system 102 and digg items desired for inclusion in the pool. If one or more usernames (of users of system 102) is provided in region 1208, a list of those users' dugg content will be included in the pool of candidate content items. In some embodiments, if both 1204 and 1208 are populated, only results matching the search and also dugg by the specified user(s) will be included in the candidate pool. In other embodiments, content items matching either condition will be included in the pool. Further, a scoring function can be used to integrate search results and user selected content and can be combined with additional sources of selection criteria to create the candidate pool.

In region 1206, advertisers can specify a series of keywords that are used to locate candidate content items in database 112, rather than the more strict searching of region 1204.

In region 1210, the advertiser can specify whether the pool of candidate items should include all stories matching the criteria specified in interface 1200, or whether the pool should be limited to only items explicitly approved by the advertiser. In some cases, such as with ongoing campaigns, an advertiser may prefer that the pool of candidate content items be dynamically adjustable. In other cases, the advertiser may prefer to limit the content items to a static list. In region 1212 the advertiser can specify as a further restriction that only content items located within a particular publisher's domain or set of domains be included.

By selecting the “advanced” button 1214, advertisers can specify several additional conditions/parameters if desired. Examples include but are not limited to requiring that content have a threshold number of diggs, have been promoted at least five days ago, not include content of a particular type (e.g., photographs), include one mandatory content item while leaving the other included content items to be algorithmically determined, be of a positive sentiment (e.g., including words such as “good” or “like”), etc. Different thresholds can also be specified based on different characteristics of the content. For example, an advertiser can require that news articles classified as Entertainment have higher digg scores in order to be included in the pool of candidate articles than articles classified as Science.

Regions 1216 and 1218, when applicable, will display a whitelist of content items (1216) that are explicitly to be included in the candidate pool, and a blacklist of content items (1218) that are expressly forbidden from consideration. The “include” and “exclude” lists can be employed based on a variety of factors. For example, Bob can specify that images (as a type of content item) be excluded from his advertisement, can specify that only business/finance articles (as a topic) be included, and can exclude content items that have a digg score under a certain threshold. Finally, in region 1220, the advertiser is able to specify/upload an image (such as a logo) to be included in the advertisement. In various embodiments, other content can be supplied via region 1220, such as a text advertisement, or an interactive advertisement that allows users to “digg” the advertisement.

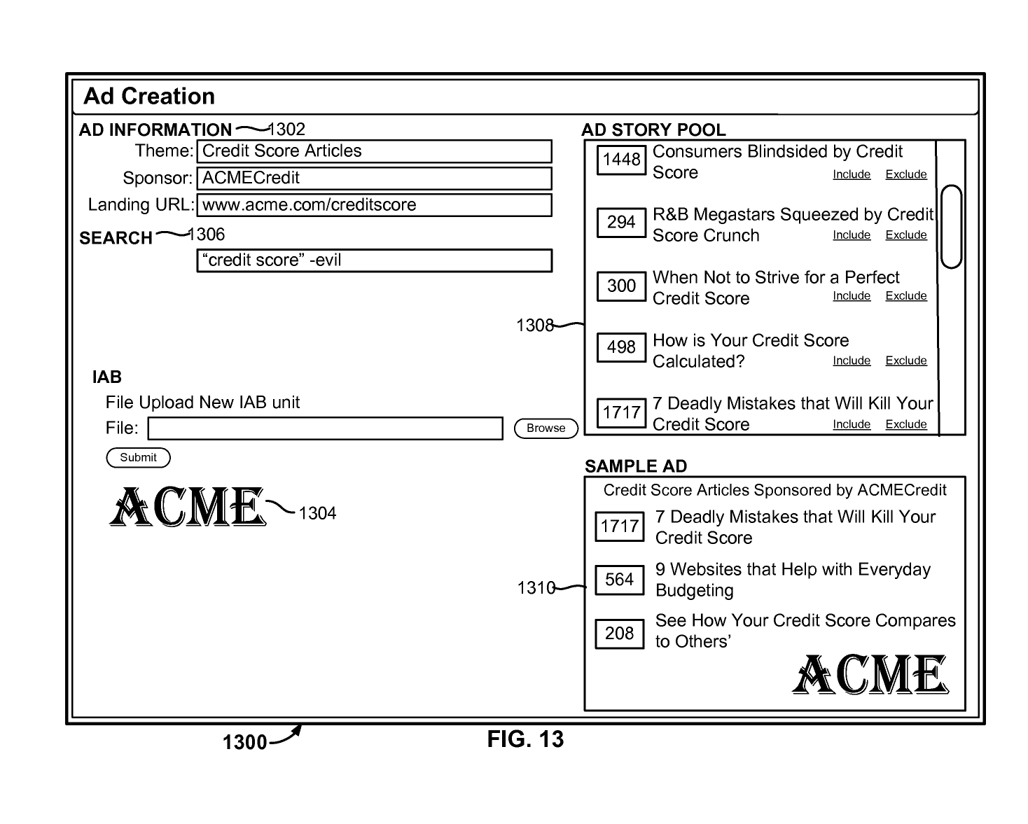

FIG. 13 illustrates an embodiment of an interface to an advertising server. The example shown is an interface to ad configuration module 136. In the following example, suppose the credit bureau, “ACME Credit,” would like to improve its reputation as a company and would also like to encourage people to request credit reports through its website. A representative of ACME Credit (“Bob”) connects to advertising server 106 and, after indicating that he would like to create a new advertisement for a new campaign, is presented with blank interface 1200.

Interface 1300 illustrates an example of interface 1200 after being populated by Bob. In region 1302, Bob has specified that the advertisement should offer as content “Credit Score Articles” sponsored by “ACMECredit.” If a user clicks on the image portion of the advertisement (1304), he should be directed to the landing page, www.acme.com/creditscore, which offers to provide visitors with a credit report.

In region 1306, Bob has specified that content items containing the phrase “credit score” in their title or summary be included in the candidate pool of content items. ACMECredit's goal is to foster positive feelings toward credit scores and thus has elected to omit content including the phrase, “evil.” In various embodiments, refinements such as that results should have a positive sentiment or negative sentiment are configurable using advanced section 1214. In addition, which regions of the content item are to be considered (e.g., title only, title and summary, entire permalink including user comments) is also configurable.

In region 1308, content items that meet Bob's criteria are displayed. Bob can further refine which content items will be included in an advertisement by using the “Include” and “Exclude” buttons. Finally, a sample ad comporting with Bob's configuration is displayed in region 1310. In various embodiments, advertisements are subject to additional constraints imposed by the operator of ad server 106, system 102, and/or a publisher on whose site the advertisement will appear. For example, publishers typically desire that visitors to their sites have as positive and relevant an experience as possible. Advertising that appears to be excessively intrusive, or uninteresting may reflect poorly on the publisher. Accordingly, publishers may choose to set minimum requirements on content items, such as requiring that they have a minimum digg score. As another example, a publisher that provides breaking news may desire that content items included in advertisements be especially timely (e.g., having been promoted within the last 48 hours), and a publisher of family-oriented content may prohibit adult-oriented content items (or items with profane titles) from being included in advertisements. In various embodiments, advertisers are able to circumvent certain baseline requirements in exchange for paying more for the advertisement.

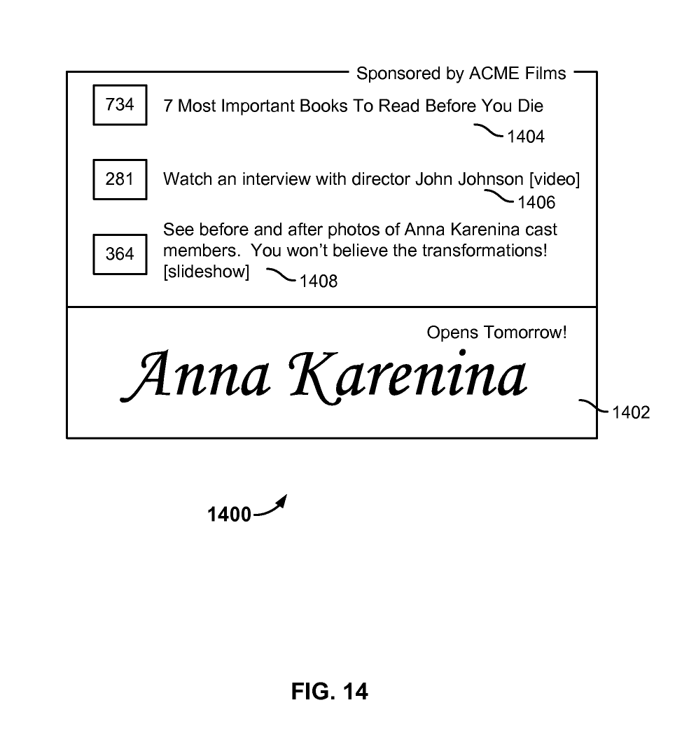

FIG. 14 illustrates an embodiment of an advertisement. In the example shown, a movie studio, “ACME Films,” has decided to run a one day ad campaign to maximize interest in the opening night of its new film, “Anna Karenina.” If a viewer of the advertisement (e.g., browsing a website with a web browser) clicks on region 1402 of the ad, he will be directed to the ACME Films website. If a viewer clicks on region 1404, he will be directed to an online literary magazine that lists the novel, Anna Karenina, at position #2 of its top 7 list. If a viewer clicks on region 1406, he will be directed to a video interview with the director of the movie (hosted by a streaming video site publisher). And, if a viewer clicks on region 1408, he will be directed to a slideshow of cast photographs (hosted by an entertainment magazine).

In the example shown, the first content item does not directly relate to the upcoming movie. However, the content item has a high digg score, and its inclusion in advertisement 1400 may result in viewers, who might not otherwise want to see the movie, becoming interested in the movie. As one example, a user that is interested in book lists may spend longer looking at advertisement 1400 due to the inclusion of the first content item than he would if the first item was not included. Further, if the user clicks on region 1404 and enjoys the content, he may navigate back to advertisement 1400 and spend at least a few moments determining whether the second or third content items will also yield interesting content if navigated to.

The third content item was submitted to system 102 by an enthusiastic fan, and the second content item was submitted to system 102 by a representative of ACME Films. In this example, suppose AMCE Films employees submitted several content items to system 102, most of which have low digg scores. By using the techniques described herein, the employees do not need to engage in A/B or other testing prior to launching their ad campaign, and can instead rely on the user base of system 102 to determine which elements will likely result in the most effective advertisement.

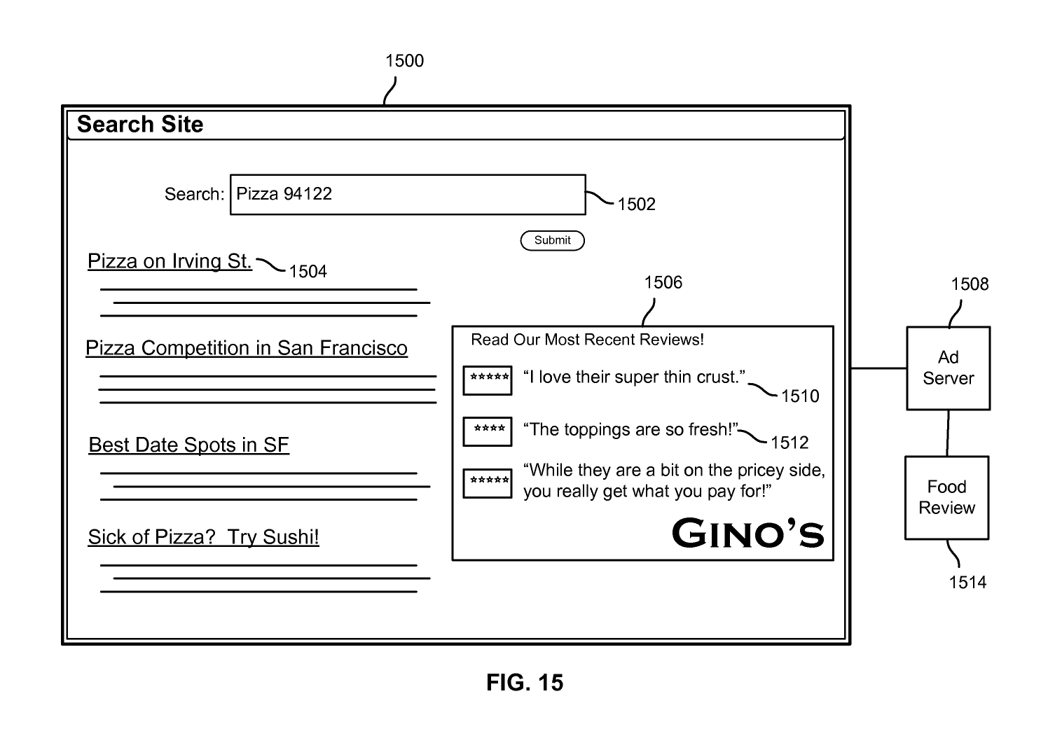

FIG. 15 illustrates a portion of a search engine provider's website as rendered in a browser. In the example shown, Alice (using client 104) would like to locate a pizzeria near her home in San Francisco. She has an “intent” (locating a pizzeria) which she indicates to site 1500 when she enters her search terms into region 1502 and hits the submit button. In the example shown, advertisements are served on behalf of site 1500 by ad server 1508. Ad server 1508 is configured to periodically receive content items and associated scores from a variety of sources, such as a restaurant review site (1514), a product review site, and a hotel review site.

In addition to the typical search results provided by site 1500 (e.g., result 1504), Alice is also shown advertisement 1506. Similar to advertisement 1400, advertisement 1506 includes three content items. In the example shown, each content item is a review of Gino's, the advertising restaurant. If Alice clicks on region 1510, she will be taken to a three paragraph review of Gino's. If she clicks on region 1512, she will be taken to a one paragraph review of Gino's that also includes a photograph. Both reviews are hosted by restaurant review site 1514. Instead of digg scores, site 1514 allows visitors to rate one another's reviews based on three categories—how useful the review is, how humorous the review is, and how cool the review is. The stars depicted in advertisement 1506 indicate an aggregate rating of the respective reviews.

When site 1500 receives search requests that indicate food-related intent, site 1500 provides the intent to ad server 1508 to assist ad server 1508 in serving advertisements. In the example shown, Gino's has configured server 1508 to generate advertisements that automatically feature the three highest rated reviews selected from the ten most recently made reviews of the restaurant.

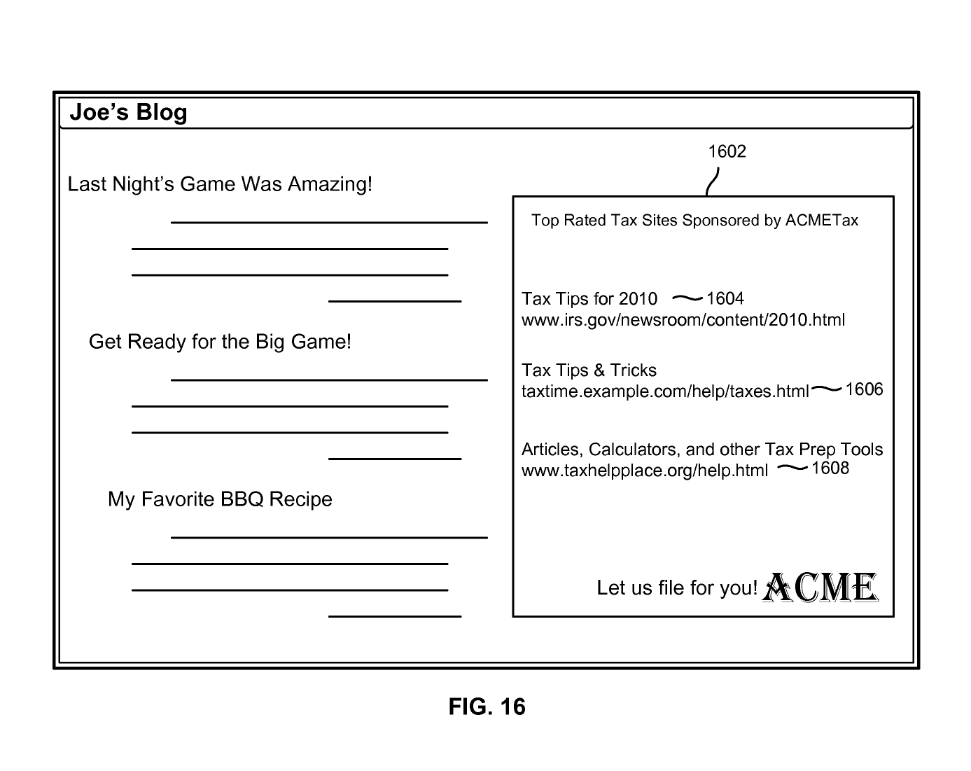

FIG. 16 illustrates a portion of a blog as rendered in a browser. In the example shown, Alice (using client 104) has directed her browser to the blog of her friend, Joe. Joe has registered his site with server 1508 as a publisher. Joe uses his blog to discuss a variety of topics and in particular sports and cooking Alice visits Joe's site from time to time and, in contrast to the example shown in FIG. 15, without a particular intent.

Advertisement 1602 includes three content items. If Alice clicks on region 1604, she will be directed to an IRS publication that offers tax time tips. If she clicks on regions 1606 or 1608, she will be directed to other tax-related websites. In the example shown, it is early April when Alice visits Joe's blog. The advertiser of advertisement 1602 is “ACMETax,” a tax preparation website. The three content items displayed were selected by ACME by performing a search (using site 1500) for “tax tools.” The three content items were the first three results (e.g., those having the highest combined link analysis and text match scores) that did not belong to competitors of ACME. In various embodiments, other portions of the search results, such as snippet text, may also be included in the advertisement. Further, the advertiser need not be associated with the subject matter of the content. For example, a beer company or dog food company could generate a tax tool advertisement similar to advertisement 1602.

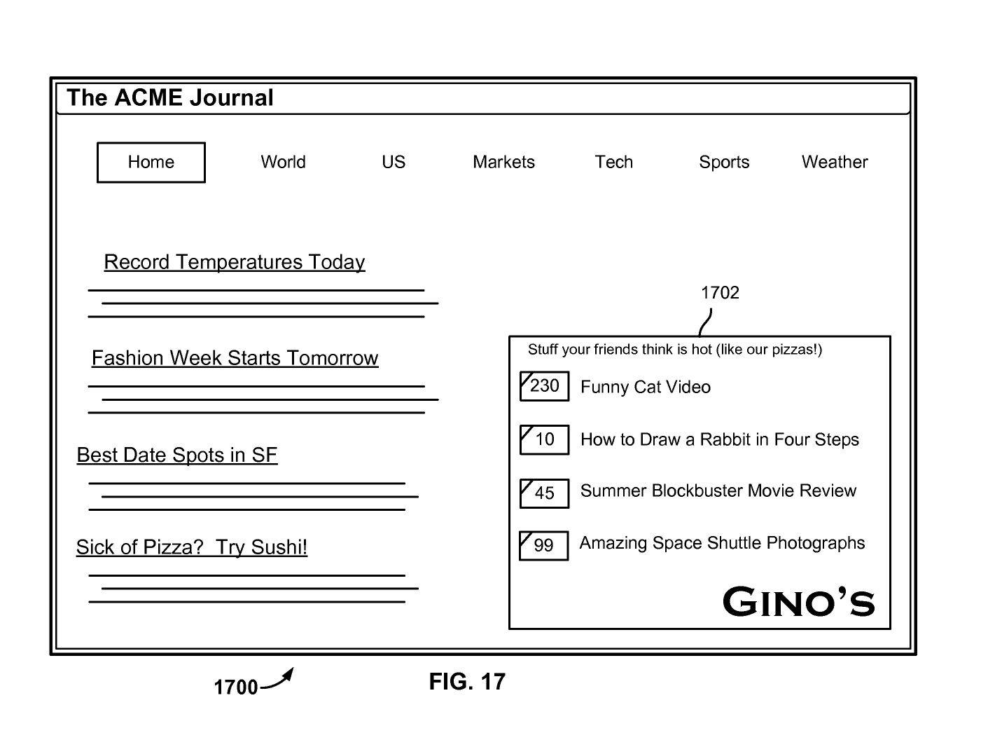

FIG. 17 illustrates a portion of a news website as rendered in a browser. In the example shown, Alice (using client 104) has directed her browser to her favorite newspaper's online site 1700, through which she is browsing without a particular intent. Advertisement 1702 is served on behalf of site 1700 by server 106.

Client 104 includes a cookie associated with Alice's use of system 102. Because of the cookie, server 106 is able to include into advertisement 1702 content items based on Alice's history/profile on system 102. For example, if Alice's profile reveals that she routinely diggs Entertainment stories and never diggs Sports articles, server 106 can be configured to tailor advertisements to better match Alice's preferences (e.g., by showing her content items pertaining to one and not the other). The advertisement shown includes four content items that Alice's friends have dugg, that she has not yet dugg. Note that the second content item has a digg score of ten, which is considerably lower than the digg score of other content items that might be presented to Alice in an advertisement. In this case, because one of Alice's friends has dugg the article, a lower threshold is used, on the theory that it might be of interest to Alice because it was of interest to her friend.

In the example shown, the content items are hosted on sites other than site 1700. In various embodiments, the content items are constrained (e.g., based on rules specified in site 1700's publisher database entry) to be items hosted by site 1700. In addition to or instead of selecting content items for inclusion in advertisement 1702 based on her friends' digging activity, Alice's own digging history can be used, including information such as Alice's favorites.

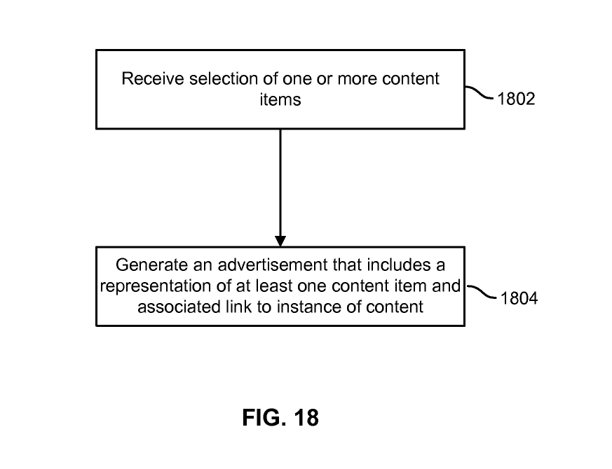

FIG. 18 is a flow chart illustrating an embodiment of a process for generating an advertisement unit. In some embodiments the process is performed by server 106. The process begins at 1802 when a selection of one or more content items is received. In some embodiments, the selection received at 1802 is received from an individual through an interface such as interface 1200. The receipt at 1802 can also occur through the use of an application program interface (API), browser plugin, etc., as applicable.

The content items each have an associated quality score. As one example, content items tracked by database 112 have associated digg scores. Other information such as how quickly an item was promoted, which users of system 102 dugg the content, and how many burries are associated with the content can also be combined in various ways to create other quality scores. Other examples of quality scores include link analysis and text match scores (e.g., in the case of web result content items), and the aggregate ratings received by review authors (e.g., as described in conjunction with FIG. 15).

At 1804, an advertisement is generated. The advertisement includes a representation of at least one content item and, for each content item included in the advertisement, an associated link. The link is configured to, when activated by a viewer of the advertisement, direct the viewer to the respective content item. As one example of the processing performed at 1804, interface 1200 can be used to create an advertisement which is in turn stored in advertisement database 110.

One example of a generated advertisement is shown in FIG. 14. In that example, each of the three content items has an associated link. When Alice clicks on the applicable region of advertisement 1400, her browser is directed to the appropriate content item. A variety of techniques can be employed in conjunction with the activation of a link by Alice. As one example, when Alice clicks on link 1404, she may be taken directly to the content. Alice can also be taken indirectly to the content by first being directed to an interstitial advertisement (e.g., for the Anna Karenina movie). As another example, the content to which Alice is directed may be framed or “skinned” with some form of branding associated with the advertiser. For example, the permalink page shown in FIG. 3 could be configured to include a large advertisement or branding message.

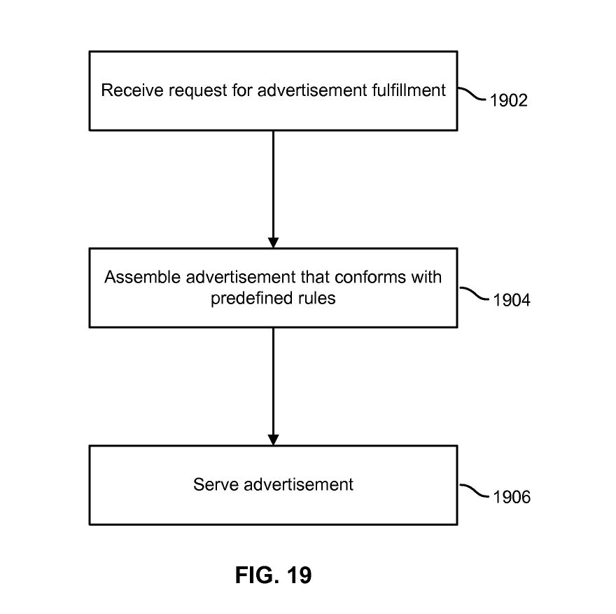

FIG. 19 is a flow chart illustrating an embodiment of a process for serving an advertisement unit. In some embodiments the process is performed by ad server 106. The process begins at 1902 when a request for an advertisement fulfillment is received. As one example, when Alice loads the web page shown in FIG. 17, ad server 106 receives a request for advertisement fulfillment at 1902.

At 1904, an advertisement that conforms with predefined rules is assembled. As one example, at 1904, ad server 106 assembles an advertising unit that conforms to the rules specified by Bob in interface 1300. Note that as new content is added to system 102 and/or as a particular content item's conformity to the rules changes, new advertisements can be constructed without needed to update the rules.

Typically, the advertisement assembled at 1904 will include a subset of valid candidate content items. For example, as shown at 1308, the pool is larger than the number of content items that can be efficiently placed in a single unit. Accordingly, which subset is used can be selected at random, or in accordance with other rules, such as rules pertaining to the amount of money available to the advertising campaign. At 1906, the advertisement is served, such as to client 104.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A system for generating an advertisement unit, comprising:
a processor configured to:
receive a selection of one or more content items other than advertisements, each of which has an associated quality score; and
generate an advertisement, the advertisement including:
a representation of at least one content item from the selected one or more content items, wherein the representation of the at least one content item is included in the advertisement based at least in part on the quality score associated with the at least one content item; and
for each included representation, an associated link configured to, when activated by a viewer of the advertisement, direct the viewer to an instance of the respective included content item; and
a memory coupled to the processor and configured to provide the processor with instructions.

2. The system of claim 1 wherein the quality score is a measure of a plurality of preferences for the content by a respective plurality of individuals.

3. The system of claim 1 wherein the processor is further configured to receive a set of one or more advertisement generation parameters.

4. The system of claim 3 wherein the set of advertisement generation parameters includes a content item timeliness threshold.

5. The system of claim 3 wherein the set of advertisement generation parameters includes a quality score threshold.

6. The system of claim 3 wherein the processor is configured to generate the advertisement based at least in part on the received set of parameters.

7. The system of claim 1 wherein the processor is configured to generate the advertisement based at least in part on a user profile.

8. The system of claim 1 wherein the advertisement further includes a visual representation corresponding to the at least one content item.

9. The system of claim 1 wherein the processor is configured to generate the advertisement in response to a request to provide a first user with the advertisement and wherein the processor is further configured to receive information associated with a previously indicated preference by the first user for at least one of the one or more content items included in the selection.

10. The system of claim 1 wherein the processor is configured to generate the advertisement in response to a request to provide a first user with the advertisement and wherein the processor is further configured to receive information associated with a previously indicated preference by a second user for at least one of the one or more content items included in the selection.

11. The system of claim 1 wherein the at least one content item includes a review and wherein the quality score is a measure of a plurality of preferences for the review by a respective plurality of individuals.

12. The system of claim 1 wherein the at least one content item includes a search result and wherein the quality score includes a text match score.

13. The system of claim 1 wherein the at least one content item includes a search result and wherein the quality score includes a link analysis score.

14. The system of claim 1 wherein the processor is configured to receive the selection at a first time and wherein the processor is configured to generate the advertisement, in response to a request for an advertisement fulfillment, at a second time that is different from the first time.

15. The system of claim 1 wherein the instance of the respective included content item includes an advertising skin.

16. The system of claim 1 wherein the associated link is a direct link to the respective included content item.

17. The system of claim 1 wherein the associated link is an indirect link to the respective included content item and wherein the associated link is a direct link to an interstitial advertisement.

18. The system of claim 1 wherein the at least one content item includes a comment and wherein the quality score is an aggregate measure of a plurality of preferences for and against the comment.

19. A method for generating an advertisement unit, comprising:
receiving a selection of one or more content items other than advertisements, each of which has an associated quality score; and
generating, using a microprocessor, an advertisement, the advertisement including:
a representation of at least one content item among the selected one or more content items, wherein the representation of the at least one content item is included in the advertisement based at least in part on the quality score associated with the at least one content item; and
for each included representation, an associated link configured to, when activated by a viewer of the advertisement, direct the viewer to an instance of the respective included content item.

20. A computer program product for generating an advertisement unit, the computer program product being embodied in a computer readable storage medium and comprising computer instructions for:
receiving a selection of one or more content items other than advertisements, each of which has an associated quality score; and
generating an advertisement, the advertisement including:
a representation of at least one content item among the selected one or more content items, wherein the representation of the at least one content item is included in the advertisement based at least in part on the quality score associated with the at least one content item; and
for each included representation, an associated link configured to, when activated by a viewer of the advertisement, direct the viewer to an instance of the respective included content item.

21. A processor-implemented method of generating an advertisement, the method comprising operating one or more computer processors to:
store a collection of content items excluding advertisements, wherein each content item is actionable to generate a preference event regarding the content item;
generate a first advertisement having first subject matter by:
identifying, in the collection, a first set of content items related to the first subject matter; and
configuring the first set of content items to be actionable;
receive a request for a plurality of content items to serve to a user; and
in response to the request, serve the first advertisement and multiple content items other than the first set of content items.

22. The method of claim 21, wherein the advertisement comprises indicia identifying the subject matter.

23. The method of claim 21, wherein:
each of the multiple content items other than the first set of content items, and each content item in the first set of content items, is accompanied by a corresponding quality score comprising a measure of preference events received for the content item.

24. The method of claim 21, wherein:
configuring the first set of content items comprises assembling representations of the content items; and
each representation of a content item in the first set of content items is actionable to display the content item.

25. The method of claim 24, wherein:
configuring the first set of content items further comprises assembling, with the representations of the content items, a representation of the first subject matter; and
the representation of the first subject matter is actionable to display additional information regarding the first subject matter.

26. The method of claim 21, wherein:
each of the multiple content items other than the first set of content items comprises an associated control that is actionable to generate a preference event regarding the associated content item; and
the first advertisement comprises a first control that is actionable to activate a link to information regarding the first subject matter.

27. The method of claim 21, wherein serving the first advertisement and the multiple content items comprises:
presenting the multiple content items; and
presenting the first advertisement with an appearance similar to an appearance of the multiple content items.

28. The method of claim 21, further comprising operating the one or more computer processors to:
receive preference events regarding content items in the collection, from users to whom the content items are served; and
associate a corresponding quality score with each content item in the collection, wherein a content item's corresponding quality score is a measure of preference events received for the content item;
wherein identifying a first set of content items comprises selecting one or more content items related to the first subject matter based at least in part of the quality scores corresponding to the selected content items.
